(19) United States
(12) Patent Application Publication
(10) Pub. No.: US 2012/0026164 A1
(43) Pub. Date: Feb. 2, 2012

(54) AUTOSTEREOSCOPIC DISPLAY DEVICE WITH A SWITCHABLE PARALLAX BARRIER FOR SWITCHING BETWEEN TWO-VIEWS 3D DISPLAY MODE AND MULTI-VIEWS 3D DISPLAY MODE, AND METHOD THEREFOR

(75) Inventors: René De La Barré, Mitweida (DE); Hans Röder, Berlin (DE)

(73) Assignee: FRAUNHOFER-GESELLSCHAFT ZUR FOERDERUNG DER ANGEWAN DTEN FORSCHUNG E.V., Muenchen (DE)

(21) Appl. No.: 13/201,275

(22) PCT Filed: Feb. 12, 2010
(86) PCT No.: PCT/EP2010/001047

§ 371 Date: Oct. 20, 2011

(30) Foreign Application Priority Data
Feb. 14, 2009 (DE) 10 2009 009 443.1

(51) Int. Cl. G06T 15/00

(52) U.S. Cl. 345/419

(57) ABSTRACT

An auto stereoscopic image display device, comprising a screen with a plurality of subpixels, a first parallax barrier and a second parallax barrier which differs from the first parallax barrier by a different slot spacing. The display device is switchable between a first mode being a multi-views 3D mode (multi-users 3D mode) in which the first parallax barrier is activated while the second parallax barrier is deactivated and a second mode being a two-views 3D mode (single-user 3D mode) in which the first parallax barrier is deactivated while the second parallax barrier is activated.

The invention relates to a monitor for displaying autostereoscopically three-dimensionally perceptible images according to the preamble of the main claim which can also be termed 3D monitor, 3D display or autostereoscopic screen. Furthermore, the invention relates to a corresponding method for displaying autostereoscopically three-dimensionally perceptible images according to the preamble of the coordinated claim.

A generic monitor comprises a screen with a large number of subpixels which can be varied in their intensity and which can be combined to form a large number of image points which comprise respectively a plurality of subpixels, and a slot grid with which light emanating from the image points can be conducted into respectively one of a plurality of adjacently situated viewing zones. The term slot grid in the present document should thereby be understood in general, i.e. to describe, apart from a screen with slots, also other optical arrangements with the same effect.

Monitors of this type are known from the state of the art and can be divided into two classes, namely single person screens, in which the image points are apportioned into two subgroups in order to display respectively one of two stereoscopic half-images, light emanating from each of these half-images being cast respectively into one of two stereo viewing zones for two eyes of a single viewer, and into multiperson screens or multiview displays, in which the image points are apportioned to a correspondingly large number of subgroups in order to display a larger number of views, and light emanating from each of these subgroups being conducted into respectively one of the corresponding number of viewing zones. In the last-mentioned case, also several persons can perceive the reproduced images autostereoscopically and three-dimensionally. Also a single viewer can then move during a lateral movement through different viewing zones and in this manner perceive different views of a displayed scene respectively three-dimensionally without tracking being required for this purpose for a single person screen. In order that a transition from one viewing zone into a next is not perceptible or scarcely perceptible by the viewer, the viewing zones are allowed to merge one into the other, which causes a relatively high mutual cross-talk of different stereo channels. For this reason, the type of image reproduction used in the case of multiperson screens is less well-suited for some scenes. A viewing distance, in these multiperson screens, is typically double to triple a format diagonal and is in particular larger than normal viewing distances from single person screens of a comparable size.

However, it is not possible with the known 3D monitors to produce optionally both portrayed types of three-dimensional image reproduction—i.e. an operation as a multiperson screen or as a single person screen—because each of these 3D monitors is suitable, because of geometric restrictions, respectively only for one of the two types of image reproduction. This involves the disadvantage that a 3D monitor from the state of the art which can be used as a multiperson screen, when only a single person uses this 3D monitor, must be operated as a multiview display although, with the other type of image reproduction with the corresponding number of pixels, in theory better image quality could be produced.

The object therefore underlying the invention is to develop a 3D monitor which can be operated optionally as a multiperson screen or as a single person screen and hence avoids the mentioned disadvantage. Furthermore, the object underlying the invention is to propose a method for displaying autostereoscopic images, with which, using a single 3D monitor, both above-described types of image reproduction are produced.

This object is achieved according to the invention by a monitor having the characterising features of the main claim in conjunction with the features of the preamble of the main claim and also by a method having the features of the coordinated claim. Advantageous embodiments and developments of the invention are revealed in the features of the dependent claims.

In addition to a first slot grid of the described type, the proposed monitor has a second slot grid. As a result of the fact that the second slot grid differs from the first slot grid by a different slot spacing, i.e. in that a slot spacing of adjacent slots of the first slot grid has a different value from a slot spacing of adjacent slots of the second slot grid, the monitor being able to be switched between a first mode in which the first slot grid is activated and the second slot grid is deactivated, and a second mode in which the second slot grid is activated and the first slot grid is deactivated, it becomes possible to use the monitor both as multiperson screen or in a multiview operation and as single person screen or in a single view operation, and in fact optionally by switching between the two modes. A horizontal spacing between respectively adjacent slots of the respective slot grid may thereby be termed slot spacing.

The monitor can therefore be designed in particular in the first mode as multiperson screen and, in the second mode, as single person screen, requirements caused thereby respectively by geometric interrelationships, resulting for the configuration of the two dissimilar slot grids.

The monitor is preferably thereby designed such that the image points in the first mode are apportioned to a large number of more than two subgroups—for example to six or more subgroups which are separate in pairs—such that light emanating from each of these subgroups of image points falls through the first slot grid at a first viewing distance at a remove from the first slot grid into respectively one of the same number of adjacently situated viewing zones, whilst the image points in the second mode are apportioned to a first and a second subgroup separate therefrom such that light emanating from the first subgroup of image points falls through the second slot grid at a second—typically smaller—viewing distance at a remove from the second slot grid into a left viewing zone for a left eye of the viewer and light emanating from the second subgroup of image points falls through the second slot grid at the second viewing distance at a remove from the second slot grid into a right viewing zone for a right eye of the viewer.

The monitor is thereby intended to be actuatable such that the image points of each of these subgroups produce in the respective viewing zone one of two, in the second mode, and a plurality of views, in the first mode, which views are perceptible for one or more persons as complementary stereoscopic half-images. The monitor can comprise for this purpose a control device for activating the subpixels, which control device is designed by programming technology such that the image information is apportioned according to these views to the different subgroups of image points.

In order, in the first mode, to enable stereoscopic vision for all head positions within a region spanned by the viewing zones, a spacing between intensity centre points of adjacent viewing zones, in the first mode, is preferably slightly smaller than in the second mode in which this spacing is chosen best corresponding to a typical eye spacing of approx. 65 mm.

A correspondingly advantageous method for displaying autostereoscopically three-dimensionally perceptible images, which can be implemented simply with a monitor of the type described here, correspondingly provides that, on a screen of a single monitor, a large number of image points is formed by respectively one or more subpixels which can be varied in their intensity, at least two subgroups of the image points respectively forming one of at least two views which can be combined to form a stereo image and light emanating from each of these subgroups of image points being conducted through a slot grid into respectively one of at least two adjacently situated viewing zones, and that the monitor is switched from a first mode, in which a first slot grid of this type is activated, into a second mode, in that the first slot grid is deactivated and a second slot grid, which is deactivated in the first mode and differs from the first slot grid by a different slot spacing, is activated.

In preferred embodiments of the method, in the first mode, a large number of more than two views are reproduced respectively on one of a corresponding number of subgroups of image points, light emanating from each of these subgroups being conducted through the first slot grid of the monitor operating in this mode as multiperson screen or in multiview operation at a first viewing distance at a remove from the first slot grid into respectively one of a corresponding number of viewing zones whilst, in the second mode, respectively one stereoscopic half-image is reproduced on a first and a second subgroup of image points which are defined typically by a different grouping of subpixels, light emanating from each of these two subgroups being conducted through the second slot grid of the monitor operating in this mode as single person screen or in single view operation at a typically smaller second viewing distance at a remove from the second slot grid into respectively one of two viewing zones. Of course, the roles of the two slot grids can also be allocated the other way round.

Apportioning the subpixels to the image points in the first mode can differ from apportioning the subpixels to the image points in the second mode. In particular, the image points in the first mode can be formed respectively from a smaller—preferably the same for each image point—number of subpixels than in the second mode. As a result, the fact can be taken into account that, with an operation as multiperson screen, a larger number of image points is required than during an operation as single person screen in order that, in this mode, a larger number of different views of one scene can be reproduced. Possibly—e.g. in the case of monochromatic screens or those in which the subpixels can be varied with respect to colour—it is even possible that the image points in the first mode are formed only by respectively one subpixel.

Each of the image points produced respectively by one subpixel group can contain, with preferred embodiments of corresponding monitors, in respectively the same number, subpixels of at least three different colours—preferably in the basic colours of red, green and blue—in order that a 3D reproduction of colour images becomes possible. Instead the monitor can also have full colour subpixels which can be varied respectively through all the desired colours. If however a colour image reproduction can be dispensed with, also a monochrome screen can of course be used.

The subpixels of the screen should preferably be disposed in lines and columns. Then a conventional matrix screen can be used to reproduce the image points. In particular when using a matrix screen with subpixels of at least three different colours, it is advantageous if the image points contain respectively subpixels from at least just as many successive lines in order that all the image points are suitable for reproducing all colours and hence no colour distortion occurs if an image point is shaded partially laterally, for example when leaving a viewing zone. In the second mode, the image points can then contain, for example in each of the at least three lines of the respective image point, respectively at least three adjacent subpixels with a colour sequence which is transposed cyclically from line to line, whilst the image points in the first mode can contain respectively fewer subpixels from each of the at least three lines than the image points in the first mode.

The slot grids can have a particularly simple configuration if the image points of each of the subgroups, mentioned further back, are disposed respectively along a family of equidistant parallel straight lines which intersect the lines at a relatively large angle. Then the slot grids can be configured in a simple grid form, with slots or strips which extend along corresponding straight lines over the entire respective slot grid. That can be achieved in particular with an arrangement in which, in each line of the screen, image points of the large number of subgroups alternate cyclically in the first mode and, in the second mode, image points of the first subgroup alternate with image points of the second subgroup.

The screen can, in particular in an embodiment as matrix screen, be provided by a liquid crystal screen which enables activation of the subpixels in the manner required for the described monitor with low complexity.

The two slot grids can be disposed in a common—preferably parallel to the screen—plane, by means of which a compact construction of the monitor can be achieved. As an alternative, the two slot screens can also be produced in two different planes which preferably lie parallel to each other and to the screen. In the last mentioned case, more variables are available with two different slot grid planes, which variables can be selected such that all the geometric conditions are maintained. In particular, the viewing distances for the two modes can then be chosen freely. However, the two slot grids should be designed in this case such that the second slot grid is transparent in the first mode and the first slot grid is transparent in the second mode.

At least one of the two slot grids can be produced by a liquid crystal display which can have a passive configuration and can have simple electrode combs with a shape corresponding to the respective slot grid. Thus with exceptionally simple means, slot grids which can be activated and deactivated optionally as required can be made available. A particularly simple construction is produced if both slot grids are produced by a single liquid crystal display, this liquid crystal display being able to be darkened wherever transparency is required in neither of the two modes. The liquid crystal display can then be configured with at least one first electrode comb for the first slot grid and with at least one second electrode comb for the second slot grid, these electrode combs being orientated such that electrodes of the at least one first electrode comb include a non-zero angle with electrodes of the at least one second electrode comb.

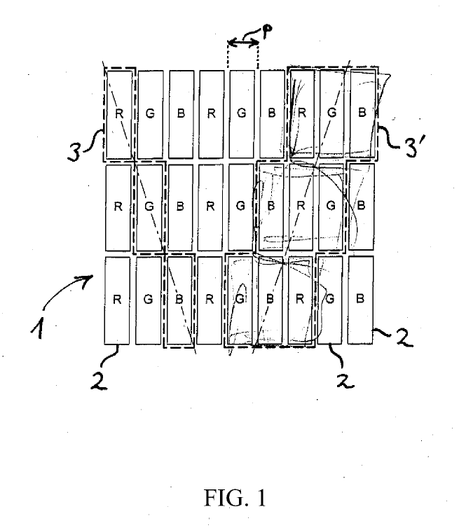

Embodiments of the invention are explained subsequently with reference to FIGS. 1 to 3. There are shown

FIG. 1 a section of a pixel plane of a liquid crystal screen which forms a main component of a 3D monitor,

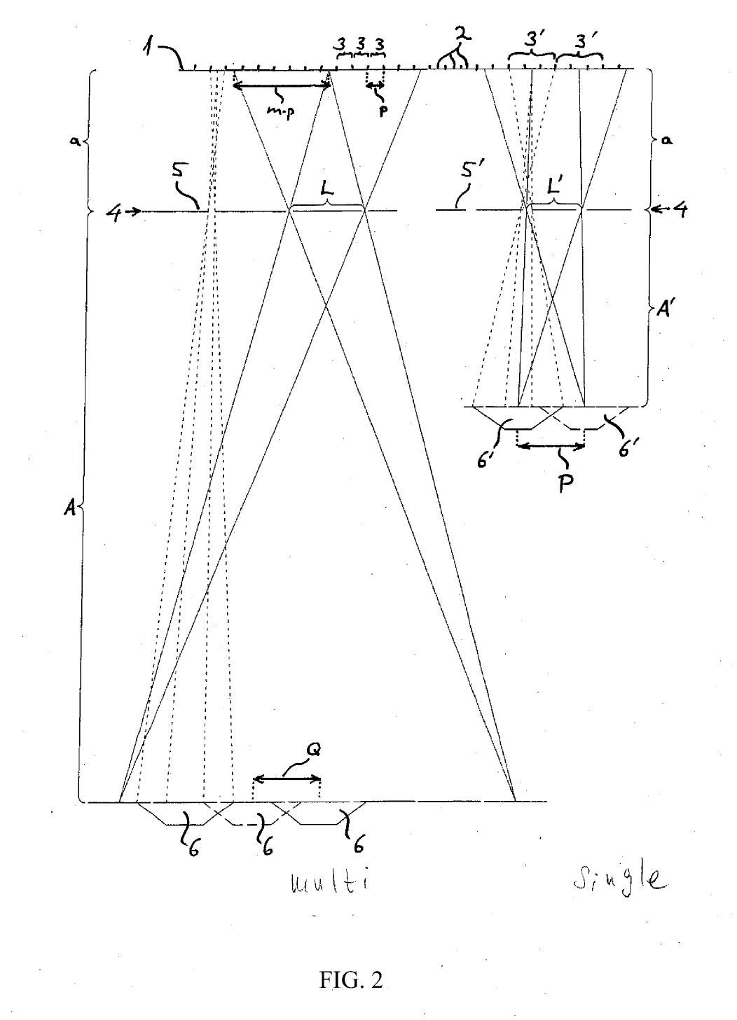

FIG. 2 in schematic representation, a view on a beam path of this 3D monitor with two different types of operation and

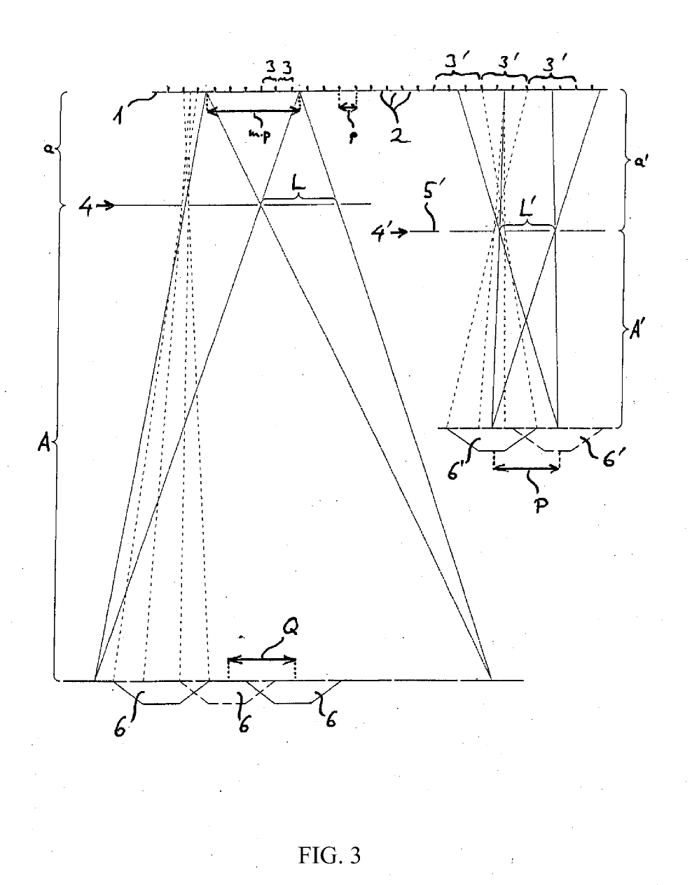

FIG. 3 a representation of a 3D monitor, corresponding to FIG. 3, in a different embodiment of the invention.

The embodiment concerns a 3D monitor which can be operated optionally in a first mode as multiperson screen or in a second mode as single person screen and which can be switched between these two modes or types of operation. As main component, this 3D monitor has a matrix screen 1 which is provided by a liquid crystal screen and has a large number of subpixels 2 which are disposed in lines and columns and can be varied in their intensity, a section of a pixel plane of which is illustrated in FIG. 1. In each line of the matrix screen 1, subpixels 2 of red, green and blue colour alternate cyclically, characterised in FIG. 1 with letters R, G and B, subpixels 2 of the same colour being disposed one above the other in the columns. Of course, also other arrangements of the subpixels 2 would also be possible with other embodiments of corresponding 3D monitors. The individual subpixels 2 have a width p of for example 0.085 mm and are dimensioned such that three adjacently situated subpixels 2 complete respectively one square.

In each of the mentioned modes, the subpixels 2 respectively are combined in groups to form image points 3 or 3′ comprising a plurality of subpixels 2 and in fact, in the first mode, to form image point 3 with respectively one red, one green and one blue subpixel 2 and, in the second mode, to form larger image points 3′ with respectively three red, three green and three blue subpixels 2. Each of the image points 3 and 3′ extends over three lines, the image points 3′, in the second mode, containing from each of these lines respectively three adjacent subpixels 2. The colours of these three subpixels 2, relative to the colours of the three subpixels 2 from the other lines of the same image point 3′, are thereby respectively transposed cyclically. Both the subpixels 2 of the image points 3 in the first mode and the subpixels 2 of the image points 3′ in the second mode thereby respectively form an oblong strip which is inclined by approx. 20° from a column direction of the matrix screen 1, the strips formed by the image points 3 in the first mode being inclined in a different direction to the strips formed by the image points 3′ in the second mode.

Both in the first mode and in the second mode the image points 3 or 3′ respectively are combined to form subgroups on which respectively one of a plurality of views of a stereo image made visible by the 3D monitor is reproduced. The image points 3 or 3′ of each of these subgroups are thereby disposed respectively along a family of equidistant parallel straight lines, one line of which is drawn as dot-dash in FIG. 1 for both modes respectively and which are inclined, relative to the column direction of the matrix screen 1, precisely like the strips formed from the respective image points 3 or 3′.

In the first mode, the image points are apportioned to a large number of m subgroups, m being able to be chosen in the present example as m=6 and m different views being reproduced on these subgroups, which are intended to be visible from respectively one of m adjacently situated viewing zones. The image points 3 of these m subgroups are disposed on the matrix screen 1 such that, in each line, image points 3 of the m subgroups alternate cyclically when the 3D monitor is operated in the first mode, i.e. as multiperson screen. In the second mode, the larger image points 3′ are apportioned to a first subgroup which is intended to be visible for a left eye of a single viewer and to a second subgroup which is intended to be visible for a right eye of this viewer, the image points 3′ of these two subgroups being apportioned, in the second mode, to the image screen 1 such that in each line image points 3′ of the first subgroup alternate with image points 3′ of the second subgroup. In the second mode, respectively one of two stereoscopic half-images is reproduced on the image points 3′ of each of these two subgroups so that the one viewer can perceive a stereo image autostereoscopically if his left eye is situated in a left viewing zone and his right eye in a right viewing zone of only two viewing zones in this second mode.

In FIG. 2, a view on the described 3D monitor is shown schematically. A cross-section extending along a line can be detected here from the matrix screen 1, limits between adjacent subpixels 2 of the matrix screen 1 being marked here by short lines perpendicular to the pixel plane.

At a small spacing a at a remove from the pixel plane of the matrix screen 1, a liquid crystal display 4 which is orientated parallel to the matrix screen 1 is disposed, which liquid crystal display can form, according to actuation, optionally a first slot grid 5 or a second slot grid 5′. The liquid crystal display 4 is thereby actuated such that it switches between the two slot grids 5 and 5′ when the mode of the 3D monitor is changed so that the first slot grid 5 is activated in the first mode and the second slot grid 5′ is deactivated, whilst, in the second mode, the second slot grid 5′ is activated and the first slot grid 5 is deactivated. Both slot grids 5 and 5′ have a large number of parallel slots which are formed by respectively one strip which remains transparent, whilst the respective slot grid 5 or 5′ outwith these slots is opaque for light emanating from the matrix screen 1. The two slot grids 5 and 5′ thereby differ from each other in particular in that a horizontal slot spacing L′ between adjacent slots of the second slot grid 5′ is slightly smaller than a horizontal slot spacing L between the respectively adjacent slots of the first slot grid 5. In FIG. 2, sections of the two slot grids 5 and 5′, illustrated in the plane defined by the liquid crystal display 4, are represented adjacently even though the liquid crystal display 4, during operation of the 3D monitor, forms respectively only the one or the other of these slot grids 5 or 5′ which respectively fill the liquid crystal display 4 over the entire surface.

Apart from the different slot spacings L and L′, the two slot grids 5 and 5′, in the present embodiment, also differ due to different orientations of the respectively parallel slots, the slots of the first slot grid 5 being orientated parallel to the straight lines, along which the image points 3 of the subgroups of image points 3 are disposed in the first mode, whilst the slots of the second slot grid 5′ extend parallel to the straight lines, along which the subgroups of image points 3′ are disposed in the second mode. For this purpose, the liquid crystal display 4 can have a passive configuration in a simple manner, having electrode combs of two different orientations which have respectively a form corresponding to the slot grid 5 or to the slot grid 5′, those electrodes which extend correspondingly to the slots of the slot grid 5 or 5′ respectively to be activated having a voltage applied respectively. In diamond-shaped surfaces in which neither the first slot grid 5 nor the second slot grid 5′ need to be transparent, the liquid crystal display 4 can be possibly darkened.

As can be detected in FIG. 2, light emanating from the image points 3 or 3′ of each subgroup is conducted through the slot grid 5 or 5′ into respectively one of several adjacently situated viewing zones 6 or 6′, the image points in the first mode having in each line respectively the width of one subpixel 2, whilst the image points 3′ in the second mode have in each line respectively a width of n subpixels, n being chosen in the present embodiment as n=3.

The first slot grid 5 is dimensioned such that, in the first mode, light emanating from each of the m subgroups of image points 3, which are separate in pairs, falls through the first slot grid 5 at a first viewing distance at a remove from the slot grid 5 into respectively one of m adjacently situated viewing zones 6. A spacing Q between intensity centre points of adjacent viewing zones 6 is, in the first mode, preferably slightly smaller than an average eye spacing in order that a viewer, during a lateral movement in which each of his eyes moves from one of the viewing zones 6 into an adjacent viewing zone 6, can perceive a stereo image at all times.

The image points 3′, which are larger in the second mode, are apportioned to only two subgroups, each of which serves to reproduce a stereoscopic half-image.

The second slot grid 5′ which is activated in the second mode is thereby dimensioned such that light emanating from the first subgroup of image points 3′ falls through this slot grid 5′ into a left viewing zone 6′ for a left eye of a viewer, this viewing zone 6′ being situated at a remove from the second slot grid 5′ at a smaller viewing distance A′, relative to A. Light emanating from the second subgroup of image points 3′ however falls through the slot grid 5′ into a right viewing zone 6′ which is situated at a remove from the second slot grid 5′ at the same viewing distance A′ for a right eye of a viewer. A spacing P between intensity centre points of the two viewing zones 6′ corresponds to a typical eye spacing of approx. 65 mm.

The image points 3 or 3′ of each of the subgroups thereby produce, in the respective viewing zone 6 or 6′, one of two views in the second mode and a plurality in the first mode which are perceptible for one or more persons as complementary stereoscopic half-images. For corresponding activation of the subpixels 2 and of the liquid crystal display 4, the 3D monitor has a control device, not illustrated, which is designed by programming technology such that it apportions image information to the mentioned views correspondingly to the different subgroups of image points 3 or 3′ which are defined differently for the two modes.

In a method for displaying autostereoscopically three-dimensionally perceptible images on the described 3D monitor in which the latter is operated in both possible types of operation, the 3D monitor is switched from the first mode in which the first slot grid 5 is activated into the second mode in that the first slot grid 5 is deactivated and the second slot grid 5′, deactivated in the first mode, is activated, or vice versa. In the first mode, a large number of m views is thereby reproduced on respectively one of the m subgroups of image points 3, light emanating from each of these subgroups being conducted through the first slot grid 5 of the 3D monitor operating in this mode as multiperson screen or in multiview operation into respectively one of the m viewing zones 6, whilst, in the second mode, respectively one stereoscopic half-image is reproduced on the first and on the second subgroup of image points 3′, light emanating from each of these two subgroups being conducted through the second slot grid of the 3D monitor operating in this mode as single person screen or in single view operation into respectively one of the two viewing zones 6′.

The following interrelationships which are produced from geometric requirements apply for the different already mentioned values of the described 3D monitor:

The mechanically fixed spacing a between matrix screen 1 and the slot grid 5″ is

a=A′·n·p/P,

n describing the number of subpixels 2 of one image point 3′ in the second mode in a screen line and is chosen in the present case as n=3. There applies for the viewing distance A in the first mode

A=A′·n·Q·/P

The interrelationship between the slot spacing or strip spacing L of the first slot grid 5 in the first mode and the slot spacing or strip spacing L′ of the second slot grid 5′ in the second mode is calculated as

L=L′·m·Q·(P+n·p)/[2n·P·(Q+P)],

which follows from the interrelationships

L′=2n·p·P/(P+n·p)

and

L=m p·Q/(Q+p)

In a case of a 20.1″ LC screen, cited merely by way of example, with a pixel pitch of 0.255 mm at a subpixel pitch of p=0.085 mm there follows therefrom, if a viewing distance of A′=750 mm is intended to be maintained in the second mode and if for the sake of simplicity P=Q=65 mm is assumed (in practice Q, as already mentioned, is chosen to be somewhat smaller) with m=6 and n=3, in particular the following values:

a=2.94 mm

A=3A′=2250 mm

L/L′=1.00262≠1

The last interrelationship shows why, of the two types of operation described here which can be produced in the case of the proposed 3D monitor with a single appliance, only either the one or the other can be applied with a conventional 3D screen.

A width B of the slots or transparent strips of the first slot grid 5 can be chosen such that

B=p·Q/[2(Q+p)]

applies, in order that at a boundary between two of the viewing zones 6 light, which emanates from two mutually corresponding image points 3 which are assigned to these two viewing zones 6, is perceived with respectively approximately halved intensity.

In modifications of the described 3D monitor in which the subpixels 2 of the matrix screen 1 can be varied by colour or are intended to be suitable merely for display of monochromatic images or grey scale images, it can suffice if the image points 3 and 3′ are formed only from subpixels 2 of one line. In this case, the image points 3 can be formed also merely by respectively a single subpixel 2—and the image points 3′ with given geometry, correspondingly from three adjacently situated subpixels.

In FIG. 3, a modification of the above-described 3D monitor is illustrated in a representation corresponding to FIG. 2, which 3D monitor differs from the already described embodiment only in that the two slot grids 5 and 5′ are not disposed in a common plane but in two different planes parallel to each other and to the matrix screen 1. For this purpose, the first slot grid 5 is produced here by a first liquid crystal display 4 and the second slot grid 5′ by a further liquid crystal display 4′, the liquid crystal display 4 forming the first slot grid 5 being configured such that it is completely or quasi completely transparent in the second mode, whilst the liquid crystal display 4′ which forms the second slot grid 5′ in the second mode is completely or quasi completely transparent in the first mode. Recurring features in FIG. 3 are characterised again with the same reference numbers. As can be deduced from FIG. 3, this 3D monitor is not subjected to so many geometric limitations because a spacing a′ between the second slot grid 5′ and the matrix screen 1 differs from the spacing a of the first slot grid 5 from the matrix screen 1 and can be chosen freely. As a result, the ratio of the viewing distances A and A′ in both modes can be chosen likewise freely in this embodiment.

The proposed monitors can be designed in addition such that they can be switched not only between the two modes previously described but in addition can be switched also for a two-dimensional image display into a third mode in which none of the slot grids is activated. As long as the slot grids which are also termed barrier grids and can be produced in very different ways, are thereby formed by means of a liquid crystal display, the latter would then have to be configured such that it is completely transparent in the third mode, i.e. has in particular no darkened places.

Finally, monitors of the described type can also be configured such that a spacing, described here in the FIGS. 2 and 3 as a or a′, between at least one of the slot grids and a subpixel plane of the screen can be adjusted. Preferably, both slot grids would then be displayable by means of a liquid crystal display which can be displaced continuously with respect to the spacing thereof relative to the matrix screen. A corresponding development of the proposed method provides correspondingly that a spacing between at least one of the slot grids and a subpixel plane of the screen is adjusted in order to vary the viewing distance.

1. A monitor for displaying autostereoscopically three-dimensionally perceptible images, comprising a screen with a large number of subpixels which can be varied in their intensity and which can be combined to form a large number of image points which comprise respectively a plurality of subpixels, and a slot grid with which light emanating from the image points can be conducted into respectively one of a plurality of adjacently situated viewing zones,
wherein the monitor has in addition to a first slot grid a second slot grid which differs from the first slot grid by a different slot spacing, and in that the monitor can be switched between a first mode in which the first slot grid is activated and the second slot grid is deactivated, and a second mode in which the second slot grid is activated and the first slot grid is deactivated.

2. The monitor according to claim 1, wherein it is designed in the first mode as multiperson screen and, in the second mode, as single person screen.

3. The monitor according to claim 1, wherein the image points in the first mode are apportioned to a large number of more than two subgroups such that light emanating from each of these subgroups of image points falls through the first slot grid at a first viewing distance at a remove from the first slot grid into respectively one of the same number of adjacently situated viewing zones,
whilst the image points in the second mode are apportioned to a first and a second subgroup separate therefrom such that light emanating from the first subgroup of image points falls through the second slot grid at a second viewing distance at a remove from the second slot grid into a left viewing zone for a left eye of the viewer and light emanating from the second subgroup of image points falls through the second slot grid at the second viewing distance at a remove from the second slot grid into a right viewing zone for a right eye of the viewer.

4. The monitor according to claim 1, wherein apportioning the subpixels to the image points in the first mode differs from apportioning the subpixels to the image points in the second mode.

5. The monitor according to claim 1, wherein the image points in the second mode are formed respectively from a larger number of subpixels than in the first mode.

6. The monitor according to claim 1, wherein each of the image points contains subpixels of three different colours in respectively the same number.

7. The monitor according to claim 1, wherein subpixels of the screen are disposed in lines and columns.

8. The monitor according to claim 7, wherein the image points contain respectively subpixels from at least three successive lines, the image points in the second mode containing respectively at least three adjacent subpixels from each of these lines, whilst the image points in the first mode contain respectively fewer subpixels from each of these lines than the image points in the first mode.

9. The monitor according to claim 7, wherein the image points of each subgroup are disposed respectively along a family of equidistant parallel straight lines which intersect the lines.

10. The monitor according to claim 7, wherein, in each line of the screen, image points of the large number of subgroups alternate cyclically in the first mode and, in the second mode, image points of the first subgroup alternate with image points of the second subgroup.

11. The monitor according to claim 1, wherein the screen is provided by a liquid crystal screen.

12. The monitor according to claim 1, wherein the two slot grids are produced in a common plane or in two different planes parallel to each other.

13. The monitor according to claim 1, wherein at least one of the two slot grids is produced by a liquid crystal display.

14. The monitor according to claim 1, wherein both slot grids are produced by a single liquid crystal display.

15. The monitor according to claim 14, wherein the liquid crystal display has at least one first electrode comb for the first slot grid and at least one second electrode comb for the second slot grid, electrodes of the first electrode comb including a non-zero angle with electrodes of the second electrode comb.

16. The monitor according to claim 1, wherein a spacing between at least one of the slot grids and a subpixel plane of the screen can be adjusted.

17. The monitor according to claim 1, wherein it can be switched in addition into a third mode for a two-dimensional image display in which none of the slot grids is activated.

18. A method for displaying autostereoscopically three-dimensionally perceptible images on a monitor with a screen on which a large number of image points is formed by respectively one or more subpixels which can be varied in their intensity, at least two subgroups of the image points respectively forming one of at least two views which can be combined to form a stereo image and light emanating from each of these subgroups of image points being conducted through a slot grid into respectively one of at least two adjacently situated viewing zones,
wherein the monitor is switched from a first mode, in which a first slot grid is activated, into a second mode, in that the first slot grid is deactivated and a second slot grid, which is deactivated in the first mode and differs from the first slot grid by a different slot spacing, is activated.

19. A method according to claim 18, wherein in the first mode, a large number of more than two views is reproduced on respectively one of a corresponding number of subgroups of image points, light emanating from each of these subgroups being conducted through the first slot grid at a first viewing distance at a remove from the first slot grid into respectively one of a corresponding number of viewing zones whilst, in the second mode, respectively one stereoscopic half-image is reproduced on a first and a second subgroup of image points of, light emanating from each of these two subgroups being conducted through the second slot grid at a second viewing distance at a remove from the second slot grid into respectively one of two viewing zones.

20. A method according to claim 19, wherein a spacing between at least one of the slot grids and a subpixel plane of the screen is adjusted in order to change the viewing distance.

21. The monitor according to claim 1, wherein the monitor is configured for use in displaying autostereoscopically three-dimensionally perceptible images.
